(19) United States
(12) Patent Application Publication
(10) Pub. No.: US 2010/0145508 A1
(43) Pub. Date: Jun. 10, 2010

(54) Collectibles dispensing apparatus and method

(76) Inventor: David Peretz, Hollywood, FL (US)

Correspondence Address: William R. Trueba., Jr. / Michael E. Tschupp;Espinosal Trueba. P.L., 3001 SW 3rd Avenue, Miami, FL, 33129, US

(21) Appl. No.: 12/584,696

(22) Filed: Sep. 10, 2009

Related U.S. Application Data
(60) Provisional application No. 61/136,569, filed on Sep. 10, 2008.

(51) Int. Cl. G06F 7/00; G07F 11/00

(52) U.S. Cl. 700/236; 700/232; 221/1

(57) ABSTRACT

The present invention is an apparatus and method for dispensing collectibles to a user comprising a housing with a user interface, such as displays, speakers, touch screens, push buttons, joy sticks, track balls, mouse(s), spinning dials, wheels, microphone and/or pull actuators. The user interface provides audio visual information related to one or more collectibles. A plurality of hoppers are coupled to a dispensing mechanism and are adapted to hold the collectibles. A controller is coupled to the user interface and the dispensing mechanism. The user may designate one or more collectibles through the user interface. The dispensing mechanism releases the designated collectibles from the appropriate hoppers. The apparatus and method may incorporate one or more games that may be configured to allow a user to affect the collectible being dispensed. Tracking the inventory of available collectibles may also affect the availability of specific collectibles.

### CROSS-REFERENCE TO RELATED APPLICATIONS

The present application is a non-provisional application which claims priority to U.S. provisional patent application Ser. No. 61/136,569, filed Sep. 10, 2008, the disclosure of which is hereby incorporated by reference in its entirety for its teachings and embodiments.

The present invention relates to an apparatus for dispensing collectibles or souvenirs to a user and a method therefore.

### BACKGROUND OF THE INVENTION

Commonly known collectible/souvenir dispensing devices typically involve the random dispensing of an item to be purchased from a common hopper containing an assortment of various available items. While these devices increase sales by incentivizing the consumer to make repeated purchases until the desired item or items are obtained through random chance, these devices quickly become frustrating and tiresome to the consumer and are additionally limited in their ability to deliver media presentations and advertising material to the consumer. These devices also fail to maximally engage the user because there is no feedback between the user's actions and the selection of the product to be dispensed.

Other collectible/souvenir dispensing devices allow the consumer to select a desired product from among various available choices, wherein the device contains a dedicated hopper for each of the different product choices, from which the desired product is dispensed. While these devices ameliorate consumer frustration by providing the desired product, they fail to maximize sales because the consumer obtains the desired product on each attempt, thereby reducing the number of purchases by a particular consumer to the number of desired products.

Furthermore, existing devices for dispensing collectible/souvenir items lack an attraction mode which, when the device is not being used by a customer, displays multimedia material on a visual display to stimulate consumer interest in the game.

There is a need for a device or apparatus that dispenses collectible and/or souvenir products from a set of available choices in a way which is entertaining to the user and induces repeat purchases by the consumer. Specifically, there is a need for a device that dispenses collectible and/or souvenir products accompanied by the display of a random game event or skill event, wherein the selection of product dispensed is determined by the outcome of the displayed game event.

For example, U.S. Pat. No. 4,518,098 to Fleischer discloses a combination vending and slot machine, but the selection of the product dispensed is not actually determined by the outcome on the devices slot machine reels. U.S. Patent Application Publication No. 2007/0276537 to Walker discloses a vending device that, after dispensing a product selected by a customer, randomly provides an entitlement to the customer following a game-themed presentation displaying the set of possible entitlement. However, none of the above-cited references discloses device of the invention.

### OBJECTS OF THE INVENTION

The following section of the written description describes some of the objects of the present invention, but the section is not exhaustive of all of invention's objects.

It is an object of the present invention to provide an apparatus that dispenses collectible and/or souvenir products from a set of available choices in a way which is entertaining to the user.

It is a further object of the present invention to provide an apparatus and method that induces repeat purchases by the consumer.

It is yet another object of the present invention to provide a device or apparatus that dispenses collectible and/or souvenir products accompanied by the display of a random game event or skill event, wherein the selection of product dispensed is determined by the outcome of the displayed game event.

It is yet another object of the present invention to provide a device or apparatus that dispenses collectible and/or souvenir products that attracts consumers by displaying audio visual presentations about the products being dispensed.

It is a further object of the present invention to provide a method of dispensing collectibles that allows the user to participate in a game that influences the selection of the product being dispensed.

### SUMMARY OF THE INVENTION

The present invention is an apparatus for dispensing one or more collectibles, souvenirs or other novelty items (collectibles is used generically and may include souvenirs and novelties) to a user comprising a housing and a user interface coupled to the housing and adapted to accept user inputs and provide audio visual information to the user. It also comprises a plurality of hoppers adapted to hold the collectibles, a dispensing mechanism coupled to the plurality of hoppers, and a controller coupled to the user interface and the dispensing mechanism. Based upon the user designating one or more collectibles through the user interface, the controller causes the user interface to display information related to the one or more collectibles and causes the dispensing mechanism to release the designated one or more collectibles from corresponding one or more of the plurality of hoppers.

In another embodiment of the present invention, the user interface further comprises means for accepting payment from the user. By way of example, the means for accepting payment may be a bill reader, a coin slot, a magnetic card reader, a bar code reader and a radio frequency (rf) receiver, or a combination of these components.

The user interface may include one or more of a touch screen, a push button, a joy stick, a track ball, a mouse, a spinning dial, a wheel, a microphone and a pull actuator. In one embodiment, the present invention the user interface includes a video display and speaker such that an audio/visual presentation is played to provide the user information related to the one or more collectibles.

In another embodiment of the present invention, the user interface includes a video display and speaker such that a multimedia presentation is played at predetermined times to attract users to the apparatus.

The controller of the present invention may be coupled to sensors corresponding to the plurality of hoppers such that feedback regarding the quantity of collectibles within the individual hoppers. This information would allow for the controller to be programmed to prevent selection of a collectible that is no longer available, or to influence the selection of collectible to be dispensed to favor those having the greater number in inventory.

In another embodiment of the present invention, the controller is programmed to operate a game. The controller causes the user interface to display information related to one or more collectibles and causes the dispensing mechanism to release the one or more collectibles from corresponding one or more of the plurality of hoppers. In one embodiment, the user input effects the outcome of the game and may influence the selection of the one or more collectibles being dispensed.

The present invention also includes a method for dispensing one or more collectibles to a user comprising the steps of providing a dispensing apparatus adapted to hold the one or more collectibles; operating a game event; displaying audio visual information regarding the one or more collectibles based upon the game event; selecting the one or more collectibles based upon the game event; and dispensing the one or more collectibles from the selecting step. In one embodiment of the method, the step of providing a dispensing apparatus includes the steps of furnishing a user interface and accepting input related to the game event via the user interface. In another embodiment of the method, the step of accepting input affects the outcome of the selecting step. The method may also further comprise the step of displaying audio visual information to attract prospective users to the dispensing apparatus. In addition, the embodiment may also include the step of determining the availability of the one or more collectibles.

### BRIEF DESCRIPTION OF THE DRAWINGS

The subject matter which is regarded as the invention is particularly pointed out and distinctly claimed in the claims at the conclusion of the specification. The foregoing, and other objects, features, and advantages of the present invention are shown and described in the following detailed description of the preferred embodiments which should be viewed in conjunction with the accompanying drawings in which:

FIG. 1 illustrates an exemplary embodiment of the collectibles dispensing apparatus of the present invention;

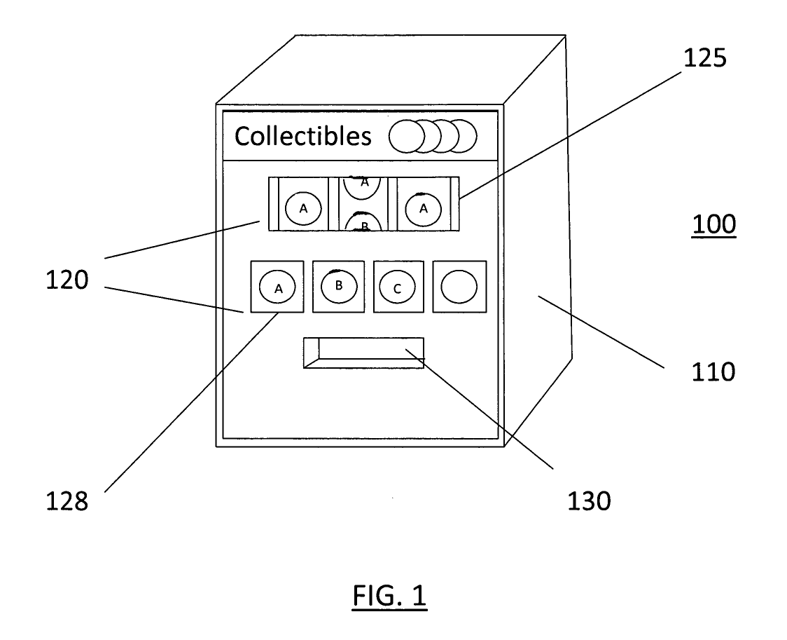

FIG. 2 is a block diagram describing the interaction between the controller and the various components of the dispensing apparatus;

FIG. 3 is a flowchart describing the overall operation of different embodiments of the present invention; and

FIG. 4 is a flowchart describing one embodiment of the present invention in greater detail.

### DETAILED DESCRIPTION OF THE PREFERRED EMBODIMENTS

The present invention relates to apparatus and methods for dispensing one or more collectibles to a user.

In the one embodiment, the apparatus 100 is enclosed in a housing 110, similar to those employed in the prior art in ATM machines, video kiosks, or slot machine cabinets.

The housing 110 contains a controller or control mechanism 250, which in this embodiment is a CPU microprocessor, and which is coupled to the housing 110 and to a dispensing mechanism 130, which it controls. In the embodiments shown the controller 250 is programmed with Visual Studio.net 2008 Team Suite Edition, Windows XP SP3, Dot net framework 3.5 spl, Microsoft DirectX, and Microsoft XNA, but may be programmed with any suitable software that is desired. The housing 110 contains means for the hoppers to be restocked by the appropriate personnel, such an access hatch or panel. Alternatively, any of the means commonly used in the art of vending devices for this purpose may be employed.

The dispensing mechanisms 130 is one of any commonly known in the art of vending devices, with an aperture to the exterior of the housing 110 through which the user can retrieve the one or more collectibles, and is coupled to a plurality of hoppers 240, adapted to hold the collectibles are contained in the housing 110. Any number of hoppers 240 may be employed as is practical and desirable. In this embodiment, there are plurality of sensors which correspond to the hoppers 240 and adapted to sense the quantity of collectibles within the hoppers 240. Optionally, the sensors may be adapted to sense merely whether any collectibles at all are present in the corresponding hopper 240. In either case, the controller 250 is programmed to prevent selection of collectible based in input from said sensors. The controller 250 can be programmed to prevent selection of a collectible when the sensors indicate that the hopper 240 in question is empty, or when the sensors indicate that the quantity of collectible in the hopper 240 in question has fallen below some programmed threshold level, or when the sensors indicate that the quantity of collectibles in the hopper 240 in question has fallen below a certain threshold level relative to the quantity of collectibles in one or more of the other hoppers 240. Optionally, any hoppers 240 commonly employed in prior art vending devices, with or without sensors, may be employed.

Coupled to the housing 110 is a user interface 120, which is adapted to accept user inputs and provide audio visual information to the user. In this embodiment, the user interface 120 contains means 200 for accepting payment from the user. In this embodiment the means 200 comprise a coin slot 210, a bill acceptor 220, and a magnetic card reader 230. However, any combination of one more means 200 of accepting payment may be used. Other means 200 may also be used, including bar code readers, RF receivers, or any other payment acceptance means employed in vending devices.

The user interface 120 includes a plurality of user inputs 128 which are chosen from the group of push buttons, joy sticks, track balls, mouses, spinning dials, wheels, microphones and pull actutators. These may be employed in any combination that is practical and desirable. Any other commonly known means of use input may also be employed in combination with the above inputs, or by itself, or among themselves.

The user interface 120 also contains a video display 125 and speaker such that an audio/visual presentation is played when the controller 250 causes the user interface to display information 120 related to the one or more collectibles. In this embodiment, the video display and speaker also play an audio/visual presentation and predetermined times, as programmed into the controller 250, to attract users to the apparatus. This is known as an Attraction Mode. 310 Optionally, the video display 125 and speaker can play other audio/visual presentations, either during the user-driven operation of the device or in the Attraction Mode. 310 These presentations may include educational information, promotion or marketing information, an info-commercial related to the collectibles, information about local attractions in the geographic area where the device is placed, or other information tailored to the location where the device is placed.

In the this embodiment, the user interface 120 provides a touch screen which serves both to accept user input through tactile means and also to display visual information to the user.

When not in use, the device is in Attraction Mode. 310 The user then provides payment through the means for accepting payment 200, in the examples shown by inserting coins. 300. The means for accepting payment 200 contains means for counting the payment submitted, in this case through the coin slot 210, and undergoes a step of counting the payment. 320. The number of credits equivalent to the value submitted is processed by the controller 250 and displayed on the user interface 120. Excess credits can be accumulated for additional play 260, or refunded via the means for accepting payment 200. If the number of credits is insufficient to cover the programmed minimum cost of using the apparatus, the apparatus will execute the step of awaiting further payment 330 and will return to the payment insertion step 300. Once a sufficient number of credits is registered, the apparatus goes into collectible vending mode 400. In the embodiment shown, this can either consist of a direct vending mode 410, in which the apparatus will dispense a coin selected by the user via the user interface 120 for a fixed price, or of a game which culminates in the dispensing of a coin at either a fixed price or at a randomly selected price. The game mode can be configured by service personnel to either charge a fixed price per play or a random price, in which case a randomly selected number of credits would be debited from the user's accumulated credit balance, according to the outcome of the game. In the embodiment shown, the games include a slot-machine style game 420 and a roulette wheel style game 430. The device can hold any number of different games, according to its data capacity. A wide variety of games may be employed, including games of skill and games of chance. The device may be configured to provide the user the ability to select which of the available modes or games to play via the user interface 120. In the alternative, the apparatus may be configured to only provide a single mode or game. The selection of available modes and games may be altered during service of the apparatus by accessing the controller 250.

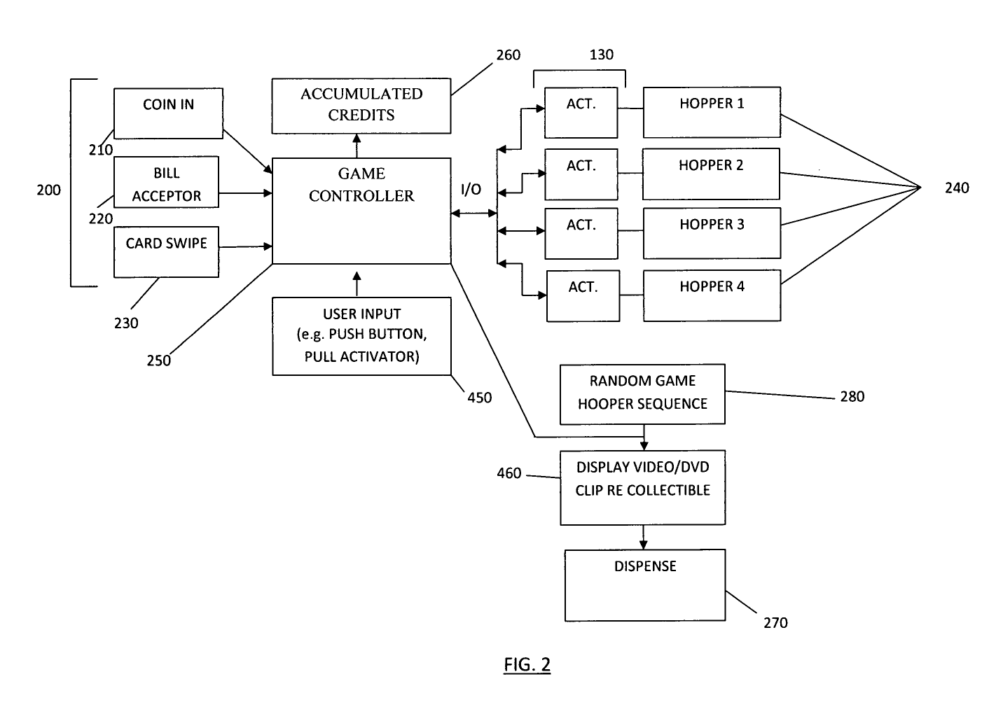

In the embodiment shown in FIG. 2, in the direct vending mode 410, once sufficient payment is accepted, a coin selection screen 440 is displayed on the user interface 120 the user then designates one or more desired collectibles by providing an input 450 through the user interface 120. The controller 125 causes the user interface 120 to display information 460 related to the one or more collectibles and causes the dispensing mechanism 130 to dispense 270 the designated one or more collectibles from the corresponding hopper or hoppers 240.

In the embodiment shown in FIG. 2, in a game mode, once sufficient payment is accepted, a game screen, such as a slot machine screen 425, or a roulette wheel screen 435 is displayed. The user initiates the game via input 450 to the user interface 120. The random outcome of this game 280 is determined by the controller 250 and displayed via the user interface 120. The controller 125 causes the user interface 120 to display information 460 related to the one or more collectibles and causes the dispensing mechanism 130 to dispense 270 the designated one or more collectibles from the corresponding hopper or hoppers 240.

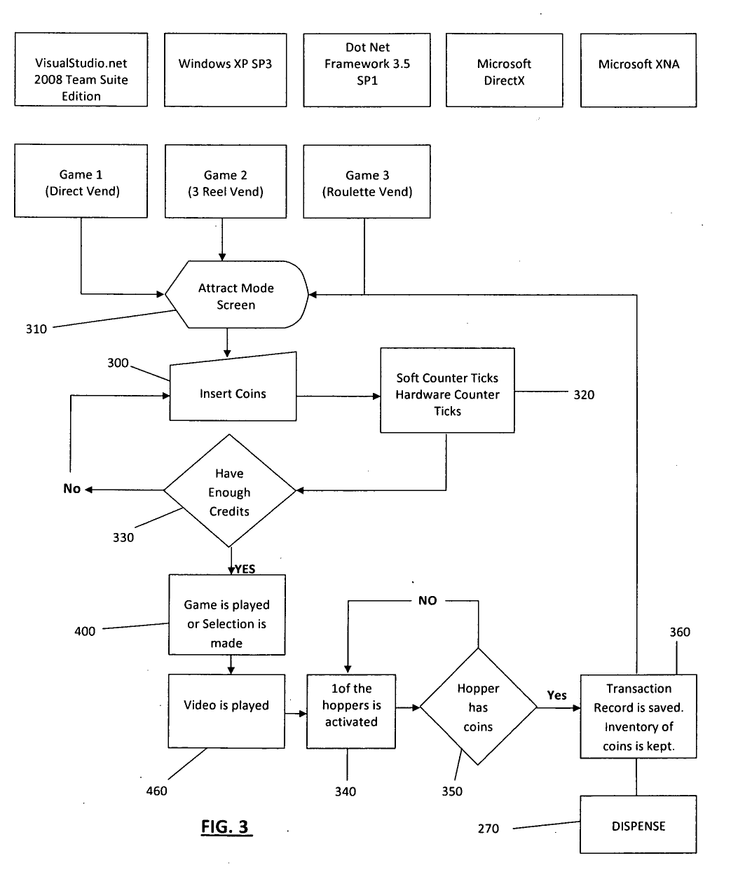

In the embodiment shown in FIG. 3, in the direct vending mode 410, once sufficient payment is accepted, a coin selection screen 440 is displayed on the user interface 120 the user then designates one or more desired collectibles by providing an input 450 through the user interface 120. The controller 125 causes the user interface 120 to display information 460 related to the one or more collectibles. The controller 250 then activates 340 the appropriate hopper 240 and causes the dispensing mechanism 130 to dispense 270 the designated one or more collectibles from the corresponding hopper or hoppers 240. If the hopper 240 is empty, the controller activates another hopper 240, until a hopper with collectibles is activated 350. The controller 250 saves a transaction record and conducts an inventory of the collectibles 360. The apparatus then returns to Attraction Mode 310.

In the embodiment shown in FIG. 3, in a game mode, once sufficient payment is accepted, a game screen, such as a slot machine screen 425, or a roulette wheel screen 435 is displayed. The user initiates the game via input 450 to the user interface 120. The outcome of this game 280, either random or influenced by user input via the user interface 120, is determined by the controller 250 and displayed via the user interface 120. The controller 125 causes the user interface 120 to display information 460 related to the one or more collectibles and causes the dispensing mechanism 130 to dispense 270 the designated one or more collectibles from the corresponding hopper or hoppers 240. If the hopper 240 is empty, the controller activates another hopper 240, until a hopper with collectibles is activated 350. The controller 250 saves a transaction record and conducts an inventory of the collectibles 360. The apparatus then returns to Attraction Mode 310.

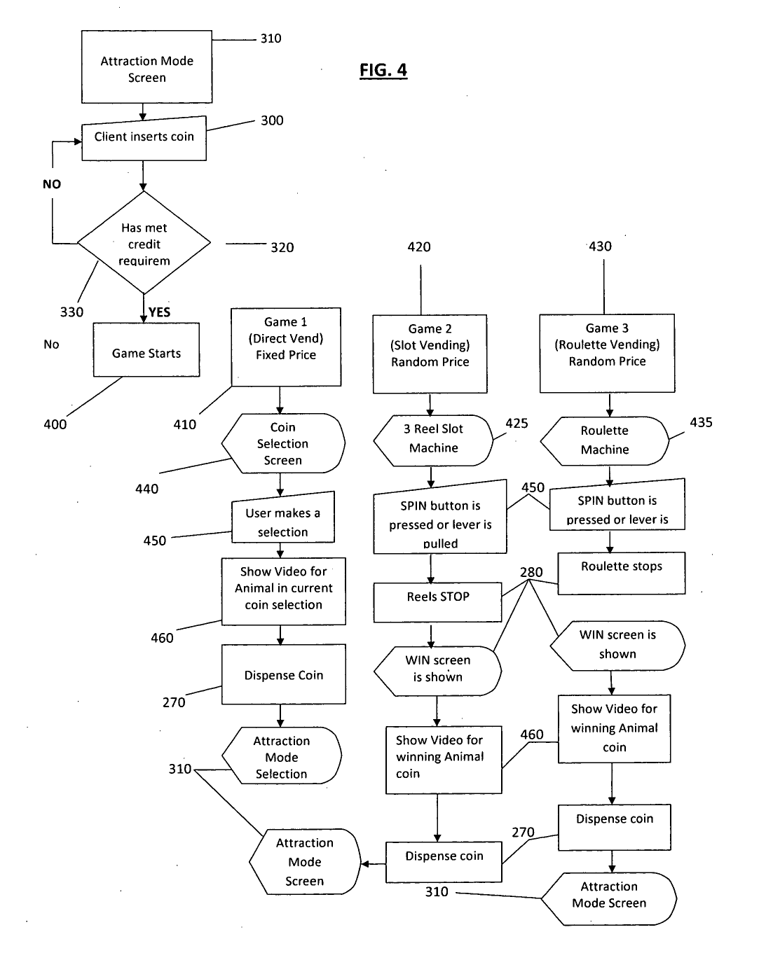

In the embodiment shown in FIG. 4, in the direct vending mode 410, once sufficient payment is accepted, a coin selection screen 440 is displayed on the user interface 120 the user then designates one or more desired collectibles by providing an input 450 through the user interface 120. The controller 125 causes the user interface 120 to display information 460 related to the one or more collectibles. The controller 250 then activates 340 the appropriate hopper 240 and causes the dispensing mechanism 130 to dispense 270 the designated one or more collectibles from the corresponding hopper or hoppers 240. The apparatus then returns to Attraction Mode 310.

In the embodiment shown in FIG. 4, in a game mode, once sufficient payment is accepted, a game screen, such as a slot machine screen 425, or a roulette wheel screen 435 is displayed. The user initiates the game via input 450 to the user interface 120. The outcome of this game 280, either random or influenced by user input via the user interface 120, is determined by the controller 250 and displayed via the user interface 120. The controller 125 causes the user interface 120 to display information 460 related to the one or more collectibles and causes the dispensing mechanism 130 to dispense 270 the designated one or more collectibles from the corresponding hopper or hoppers 240. The apparatus then returns to Attraction Mode 310.

It will be clearly understood by those skilled in the art that the foregoing description has been made in terms only of the most preferred specific embodiments. Therefore, many other changes and modifications clearly and easily can be made that are also useful and outside the existing art without departing from the scope of the present invention.

It is important to note that the embodiments of the invention described below are only examples of some of the uses of the teachings described herein. In general, statements made in the specification do not limit any of the various claimed inventions. Moreover, some statements may apply to some inventive features but not to others. Unless otherwise indicated, singular elements may be in the plural and vice versa with no loss of generality. Similar reference numerals and letters represent similar components and system features throughout the drawings and the written description. The claims appended hereto are meant to cover modifications and changes within scope and spirit of the present invention.

What is claimed is:

1. An apparatus for dispensing one or more collectibles to a user comprising:
a housing;
a user interface coupled to said housing and adapted to accept user inputs and provide audio visual information to the user;
a plurality of hoppers adapted to hold the one or more collectibles;
a dispensing mechanism coupled to said plurality of hoppers;
a controller coupled to said user interface and said dispensing mechanism;
wherein based upon the user designating the one or more collectibles through said user interface, said controller causes said user interface to display information related to the one or more collectibles and causes said dispensing mechanism to release the designated one or more collectibles from corresponding one or more of said plurality of hoppers.

2. The apparatus of claim 1 wherein said user interface further comprises means for accepting payment from the user.

3. The apparatus of claim 2 wherein said means for accepting payment is comprised of one of a bill reader, a coin slot, a magnetic card reader, a bar code reader and an rf receiver.

4. The apparatus of claim 1 wherein said user interface includes a touch screen.

5. The apparatus of claim 1 wherein said user interface includes a user input from the group consisting of a push button, joy stick, track ball, mouse, spinning dial, wheel, microphone and a pull actuator.

6. The apparatus of claim 1 wherein said user interface includes a video display and speaker such that an audio/visual presentation is played when said controller causes said user interface to display information related to the one or more collectibles.

7. The apparatus of claim 1 wherein said user interface includes a video display and speaker such that an audio/visual presentation is played at predetermined times to attract users to the apparatus.

8. The apparatus of claim 1 further comprising a plurality of sensors corresponding to said plurality of hoppers, said plurality of sensors coupled to said controller and adapted to sense the quantity of collectibles within said hoppers, said controller programmed to prevent selection of a collectible based on input from said sensors.

9. An apparatus for dispensing one or more collectibles to a user comprising:
a housing;
a user interface coupled to said housing and adapted to accept user inputs and provide audio visual information to the user;
a plurality of hoppers adapted to hold the one or more collectibles;
a dispensing mechanism coupled to said plurality of hoppers;
a controller coupled to said user interface and said dispensing mechanism, said controller programmed to operate a game;
wherein based upon an outcome of said game, said controller causes said user interface to display information related to the one or more collectibles and causes said dispensing mechanism to release the one or more collectibles from corresponding one or more of said plurality of hoppers.

10. The apparatus of claim 9 wherein said user interface further comprises means for accepting payment from the user.

11. The apparatus of claim 10 wherein said means for accepting payment is comprised of one of a bill reader, a coin slot, a magnetic card reader, a bar code reader and an rf receiver.

12. The apparatus of claim 9 wherein said user interface includes a touch screen.

13. The apparatus of claim 9 wherein said user interface includes a user input from the group consisting of a push button, joy stick, track ball, mouse, spinning dial, wheel, microphone and a pull actuator.

14. The apparatus of claim 9 wherein said user interface includes a video display and speaker such that an audio/visual presentation is played when said controller causes said user interface to display information related to the one or more collectibles.

15. The apparatus of claim 9 wherein said user interface includes a video display and speaker such that an audio/visual presentation is played at predetermined times to attract users to the apparatus.

16. The apparatus of claim 9 further comprising a plurality of sensors corresponding to said plurality of hoppers, said plurality of sensors coupled to said controller and adapted to sense the quantity of collectibles within said hoppers, said controller programmed to prevent selection of a collectible based on input from said sensors.

17. A method for dispensing one or more collectibles to a user comprising:
providing a dispensing apparatus adapted to hold the one or more collectibles;
operating a game event;
displaying audio visual information regarding the one or more collectibles based upon said game event;
selecting the one or more collectibles based upon said game event; and
dispensing the one or more collectibles from the selecting step.

18. The method of claim 17 wherein the step of providing a dispensing apparatus includes the step of furnishing a user interface; and
wherein the method further comprises the step of accepting input related to said game event via said user interface.

19. The method of claim 18 wherein said accepting input step affects said selecting step.

20. The method of claim 17 further comprising the step of displaying audio visual information to attract prospective users to said dispensing apparatus.

21. The method of claim 17 wherein said selecting step includes the step of determining the availability of the one or more collectibles.
